(19) United States
(12) Patent Application Publication
(10) Pub. No.: US 2024/0338878 A1
(43) Pub. Date: Oct. 10, 2024

(54) SYSTEMS AND METHODS FOR 3D-AWARE IMAGE GENERATION

(71) Applicant: Datum Point Labs Inc., Jackson, WY (US)

(72) Inventors: Jeong-gi Kwak, Seoul (KR); Hanseok Ko, Seoul (KR)

(21) Appl. No.: 18/625,491

(22) Filed: Apr. 3, 2024

Related U.S. Application Data
(60) Provisional application No. 63/457,570, filed on Apr. 6, 2023.

(51) Int. Cl. G06T 15/00; G06T 11/00

(52) U.S. Cl. CPC G06T 15/00; G06T 11/001

(57) ABSTRACT

Embodiments described herein provide systems and methods for 3D-aware image generation. A system receives, via a data interface, a plurality of control parameters and a view direction. The system generates a plurality of predicted densities based on a plurality of positions and the plurality of control parameters. The densities may be predicted by applying a series of modulation blocks, wherein each block modulates a vector representation based on control parameters that are used to generate frequency values and phase shift values for the modulation. The system generates an image based on the plurality of predicted densities and the view direction.

### CROSS REFERENCE(S)

The instant application is a nonprovisional of and claim priority under 35 U.S.C. 119 to U.S. provisional application No. 63/457,570, filed Apr. 6, 2023, which is hereby expressly incorporated by reference herein in its entirety.

### TECHNICAL FIELD

The embodiments relate generally to systems and methods for 3D-aware image generation.

### BACKGROUND

Over the years, 2D GANs have been utilized in portrait generation. However, they lack 3D understanding in the generation process, thus they suffer from a multi-view inconsistency problem. To alleviate the issue, 3D-aware GANs have been proposed and shown results, but 3D GANs struggle with faithfully editing semantic attributes. Therefore, there is a need for improved systems and methods for 3D-aware image generation.

### BRIEF DESCRIPTION OF THE DRAWINGS

FIG. 1 illustrates a framework for 3D-aware image generation, according to some embodiments.

FIG. 2 illustrates a simplified diagram of an exemplary SURF block, according to some embodiments.

FIG. 3 illustrates additional details of the 3D-aware image generation framework of FIG. 1, according to some embodiments.

FIG. 4 illustrates a framework for a 3D-controllable image generation framework, according to some embodiments.

FIG. 5 is a simplified diagram illustrating a computing device implementing the framework described herein, according to some embodiments.

FIG. 6 is a simplified diagram illustrating a neural network structure, according to some embodiments.

FIG. 7 is a simplified block diagram of a networked system suitable for implementing the framework described herein.

FIGS. 8A-8B are example logic flow diagrams, according to some embodiments.

FIGS. 9A-9B are exemplary devices with digital avatar interfaces, according to some embodiments.

FIGS. 10-13 provide charts illustrating exemplary performance of different embodiments described herein.

FIG. 14 illustrates exemplary generated images, according to some embodiments.

### DETAILED DESCRIPTION

Over the years, 2D GANs have been utilized in portrait generation. However, they lack 3D understanding in the generation process, thus they suffer from a multi-view inconsistency problem. To alleviate the issue, 3D-aware GANs have been proposed and shown results, but 3D GANs struggle with faithfully editing semantic attributes.

A radiance field is a representation of a static 3D object or scene that maps a 3D location and 2D viewing direction to a color value. A Neural radiance field (NeRF) is a radiance field implemented by a neural network (e.g., encoded as weights in a multi-layer perceptron MLP). In some embodiments, a NeRF may be configured to output a color and volume density for each 3D location in the scene based on viewing angle. NeRF-GANs learn 3D geometry from unlabeled images yet allow control of 3D camera views based on a volume rendering. Despite the advantages, 3D GANs based on a pure NeRF network require tremendous computational resources and generate blurry images. 3D GANs have difficulty with attribute-controllable generation or real image editing because their latent space has been rarely investigated for interpretable generation. Embodiments herein include solutions to overcome these weaknesses of 2D GANs and 3D-aware GANs. First, a novel 3D-aware GAN described herein, SURF-GAN, is capable of discovering semantic attributes during training and controlling them in an unsupervised manner. Further, the prior of SURF-GAN may be injected into StyleGAN to obtain a high-fidelity 3D-controllable generator as described herein. Unlike existing latent-based methods allowing implicit pose control, the 3D-controllable StyleGAN described herein enables explicit pose control over portrait generation. This distillation allows direct compatibility between 3D control and many StyleGAN-based techniques (e.g., inversion and stylization), and also brings an advantage in terms of computational resources.

Embodiments described herein provide a number of benefits. For example, the 3D-aware GAN image generation framework described herein can enable controllable semantic attributes for image generation in an unsupervised manner. By injecting editing directions from the low-resolution 3D-aware GAN into the high-resolution 2D StyleGAN, a system may achieve a 3D controllable generator which is capable of explicit control over pose and 3D consistent editing. Methods described herein are directly compatible with various well-studied 2D StyleGAN-based techniques such as inversion, editing or stylization. The distillation of SURF-GAN into a 2D StyleGAN system allows direct compatibility between 3D control and many StyleGAN-based techniques (e.g., inversion and stylization), and also brings an advantage in terms of computational resources. Higher fidelity images, with greater adherence to controlled inputs may be achieved therefore using fewer computation and/or memory resources than with existing models.

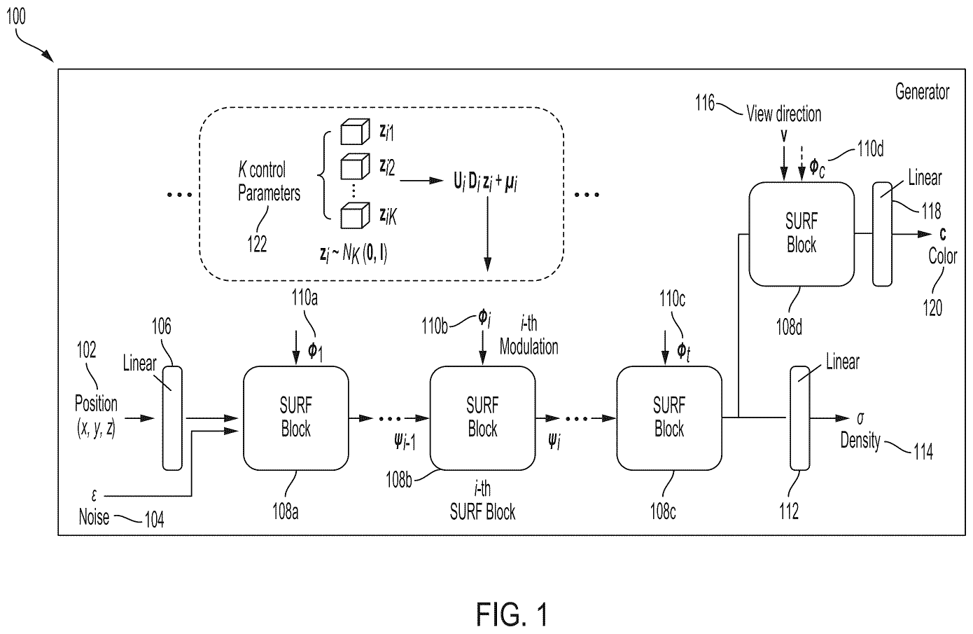

FIG. 1 illustrates a framework 100 for 3D-aware image generation, according to some embodiments. Framework 100 includes a 3D-aware GAN, i.e., SURF-GAN, which can discover semantic attributes by learning layer-wise SUbspace in implicit neural radiance (INR) neural radiance field (NeRF)-based generator in an unsupervised manner. The discovered semantic vectors can be controlled by corresponding parameters, thus this property allows for manipulation of semantic attributes (e.g., gender, hair color, etc.) as well as explicit pose. Existing 2D GANs synthesize output images directly with sampled latent vectors, such as StyleGAN as described in Karras et al., A style-based generator architecture for generative adversarial networks, Conference on Computer Vision and Pattern Recognition (CVPR), 2019. NeRF-based generators, however, generate a radiance field before rendering a 2D image based on the radiance field, for example, π-GAN as described in Chan et al., Pi-GAN: Periodic implicit generative adversarial networks for 3d-aware image synthesis, Conference on Computer Vision and Pattern Recognition (CVPR), 2021.

Given a position 102 x∈ [symbol] ³ and a viewing direction 116 v∈ [symbol] ², a NeRF-based generator may predict a volume density 114 σ(x)∈ [symbol] ₊ and the view-dependent RGB color 120 c (x, v)∈ [symbol] ³ of the input point. The points are sampled from rays of camera, and then an image is rendered into 2D grid with a volume rendering technique. To produce diverse images, existing NeRF-GAN methods adopt StyleGAN-like modulation, where some components in the implicit neural network, e.g., intermediate features or weight matrices are modulated by sampled noise passing through a mapping network. Thereby, a NeRF-GAN can control the pose by manipulating viewing direction v and change identity by injecting different a noise vector. Nevertheless, it is ambiguous how to interpret the latent space and how to disentangle semantic attributes of NeRF-GAN for controllable image generation.

Framework 100 (i.e., SURF-GAN), captures the disentangled attributes in layers of a NeRF network. FIG. 1 shows the overview of SURF-GAN. The generator consists of t+1 SURF blocks 108 (t for shared layers and one for color layer). The x,y,z position 102 may be input to a linear layer 106 to generate a vector embedding of the position. This may be used as the input to the first SURF block 108. Noise 104 may be added to the output of linear layer 106. FIG. 1 shows SURF blocks 108a, 108b, 108c, and 108d, but more or fewer SURF blocks 108 may be utilized depending on the selected value for t. SURF blocks 108 use feature-wise linear modulation (FILM) to transform the intermediate features with frequencies γᵢ and phase shifts βᵢ, and followed by SIREN activation. SIREN activation may be performed, for example, as described in Sitzmann et al., Implicit neural representations with periodic activation functions, Advances in Neural Information Processing Systems (NeurIPS), 2020.

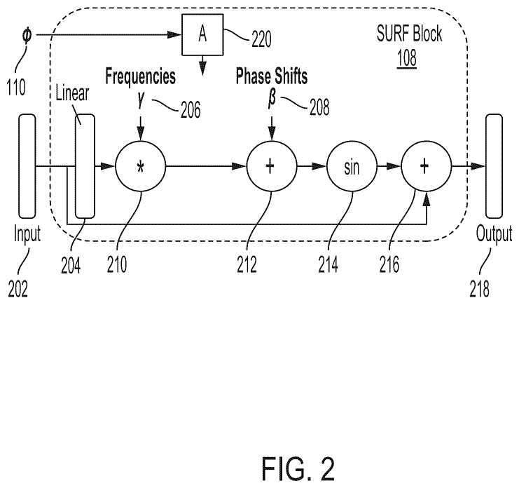

Individual SURF blocks 108 at an i^{th} layer may be represented as

$${ψ}_{i} = {SURF}_{i} ( {ψ}_{i - 1} , {ϕ}_{i} ) = sin ( {γ}_{i} \cdot ( {W}_{i} {ψ}_{i - 1} + {b}_{i} ) + {β}_{i} ) + {ψ}_{i - 1} \qquad ( 1 )$$

where ψᵢ₋₁ denotes the input feature 202, and ϕᵢ denotes modulation of i^{th} layer, illustrated as ϕ 110. A different modulation 110 may be applied at each SURF block 108, for example FIG. 1 illustrates modulations 110a, 110b, 110c, and 110d. Wᵢ and bᵢ represent the weight matrix and bias vector respectively for linear layer 204. Additional details of SURF blocks 108 are described in FIG. 2. In the SURF-GAN model, a subspace embedded in each layer determines the modulation. Each subspace has orthogonal basis and it can be updated during training. The basis may be learned to capture semantic modulation. In the case of i^{th} layer, a specific subspace determines the modulation ϕ 110 of i^{th} layer of the network. It consists of learnable matrices, orthonormal basis Uᵢ=[uᵢ₁, . . . u_{iK}] and a diagonal matrix Dᵢ=diag (dᵢ₁, . . . d_{iK}). Each column of Uᵢ plays a role of sub-modulation and it is updated to discover a meaningful direction that results in semantic change in image space. dᵢ₁, . . . d_{iK} serve as scaling factors of corresponding basis vectors uᵢ₁, . . . u_{iK}. The latent control parameters 122, zᵢ∈ [symbol] ^{K} is a set of K scalar control parameters, i.e.,

$${z}_{i} = \{ {z}_{ij} ∈ ℝ \vert {z}_{ij} \sim ( 0 , 1 ) , j = 1 , … , K \} \qquad ( 2 )$$

where zᵢⱼ is a coefficient of sub-modulation dᵢⱼuᵢⱼ. Hence, the modulation of i^{th} layer ϕᵢ 110 is decided by weighted summation of K sub-modulations with zᵢ 122, i.e,

$${ϕ}_{i} = {U}_{i} {D}_{i} {z}_{i} + {μ}_{i} = {\sum }_{j = 1}^{K} {z}_{ij} {d}_{ij} {u}_{ij} + {μ}_{i} \qquad ( 3 )$$

where the marginal vector μᵢ is employed to capture shifting bias.

FIG. 2 illustrates a simplified diagram of an exemplary SURF block 108, according to some embodiments. In some embodiments, SURF block 108 implements the function of equation (1) as described above. SURF block 108 receives an input 202 (e.g., from another SURF block 108, or from linear layer 106). Modulation input 110 is input to an affine transformation 220 for matching dimension and obtaining frequency γᵢ and phase shift βᵢ. Input 202 may be passed to a linear layer 204 (e.g., modulated according to weight matrix Wᵢ and bias vector bᵢ). The output of linear layer may by modulated by frequencies 206 at multiplication 210, and offset by phase shifts 208 at summation 212. The output of summation 212 may be input to sin function 214. Unlike other NeRF-GANs, SURF-GAN may include a skip connections (e.g., from input 202 to sum 216) to prevent drastic change of modulation vectors in training. Sum 216 may sum the output of sin function 214 and the skip connection from input 202 in order to provide output 218. Output 218 may then be provided as an input to a subsequent SURF block 108 and/or be used to generate an output.

Returning to the discussion of FIG. 1, SURF-GAN layers may learn variations of meaningful modulation controlled by randomly sampled z during training. Additionally, an input noise ϵ may also be injected to capture other variations missed by the layers. To improve the disentanglement of attributes and to prevent the basis from falling into a trivial solution, a regularization loss may be used to guarantee the column vectors of Uᵢ to be orthogonal following EigenGAN, i.e.,

$${ℒ}_{reg} = {𝔼}_{i} [ {‖ {U}_{i}^{T} {U}_{i} - I ‖}_{1} ] \qquad ( 4 )$$

The output of SURF block 108c may be input to a linear layer 112 to generate density 114. An additional SURF block 108d may be used conditioned by modulation 110d and view direction 116. The output of SURF block 108d may be input to a linear layer 118 to generate output color 120. The generated density 114 and color 120 may be generated for each point in a radiance field. The points may be sampled from rays of a (virtual) camera, and then an image may be rendered into 2D grid with a volume rendering technique to generate an output image At inference, the discovered semantic attributes can be controlled by manipulating corresponding element in z of control parameters 122. In addition, SURF-GAN enables explicit control over pose using viewing direction 116, represented as v.

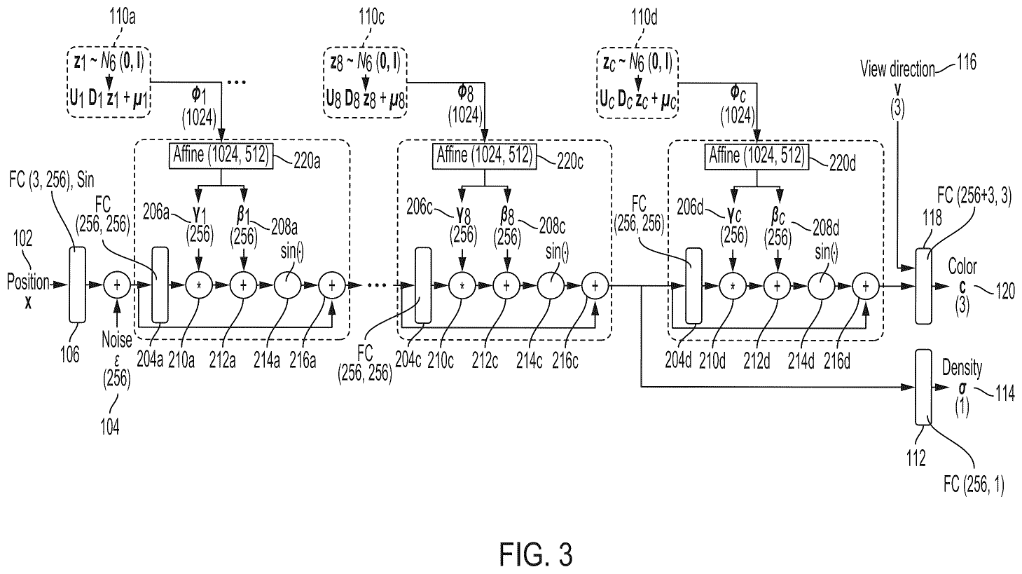

FIG. 3 illustrates additional details of the 3D-aware image generation framework 100 of FIG. 1, according to some embodiments. FIG. 3 illustrates SURF blocks 108a, 108c, and 108d, linear layers 106, 112, and 118, and modulation inputs 110a, 110c, and 110d. As illustrated, SURF blocks 108a, 108c, and 108d include respective linear layers, multipliers, summers, sin functions, and affine transformations as described in FIG. 2. FIG. 3 further details exemplary sizes of the corresponding layers/vectors. For example, linear layer 112 may be a fully connected linear layer with 3-dimensional input (i.e., x,y,z) and 256-dimensional output vector, with a sinusoidal modulation. Linear layer 112 may receive a 256-dimensional vector as an input, and output a single-dimensional density 114 predicted for the indicated position 102. Linear layer 118 may receive a 256-dimensional vector from the final SURF block 108 concatenated with the 3-dimensional view direction to generate a 3-dimensional output color 120 (e.g., in RGB format, HSV format, etc.). As illustrated, noise 104 may be injected after linear layer 106.

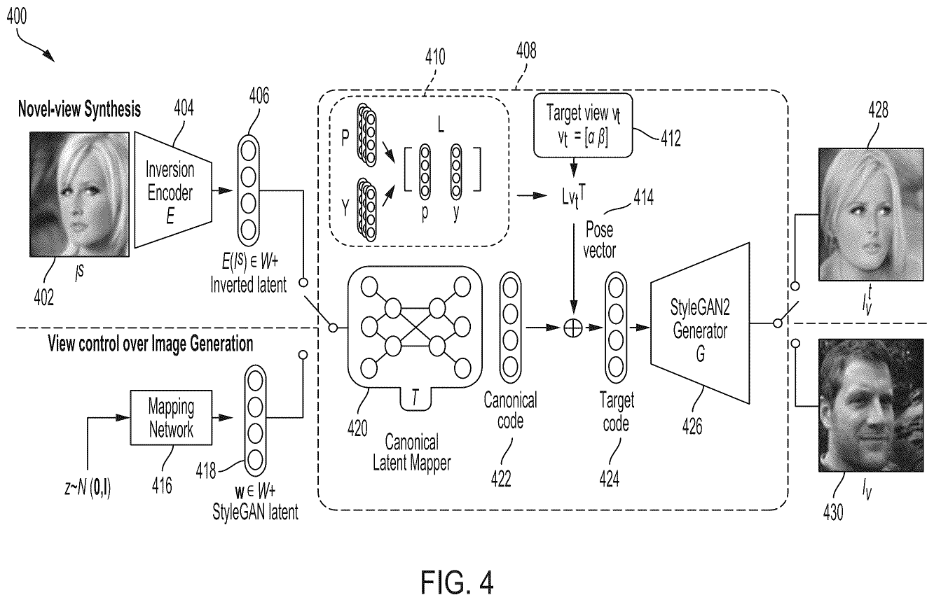

FIG. 4 illustrates a framework 400 for a 3D-controllable image generation framework 400, according to some embodiments. With the proposed SURF-GAN described in FIGS. 1-3, a 3D-controllable generator 408 may be trained by using SURF-GAN to modify Style-GAN into a 3D-controllable generator. The prior of 3D-aware SURF-GAN may be injected into the expressive and disentangled latent space of 2D StyleGAN. Unlike the previous methods that allow for only implicit pose control, Style-GAN modified as described herein enables explicit control over pose. This allows the generator to synthesize accurate images based on a conditioned target view. By utilizing SURF-GAN which consists of NeRF layers as a generator of pseudo multi-view images, the transformed StyleGAN can learn elaborate control over 3D camera pose with latent manipulation. As described herein, methods may find several orthogonal directions related to the same pose attribute, and explicit control over the pose may be accomplished by a combination of these directions. With a GAN inversion encoder, 3D controllable StyleGAN can be extended to the task of novel pose synthesis from a real image.

In addition to 3D perception, controllability of semantic attributes that SURF-GAN finds may also be injected into the 3D-controllable image generator. More pose-robust latent paths in the latent space of StyleGAN may be identified because SURF-GAN can manipulate a specific semantic attribute while keeping view direction unchanged. Moreover, the 3D-controllable generator allows further applications related to StyleGAN family, e.g., 3D control over stylized images generated by fine-tuned StyleGAN. Embodiments described herein neither require 3D supervision nor require auxiliary off-the-shelf 3D models (e.g., 3DMM or pose detector) in both training and inference because SURF-GAN learns 3D geometry from unlabeled 2D images from scratch.

In order to make StyleGAN be capable of explicit control over pose when given arbitrary latent code, SURF-GAN may be utilized as a pseudo ground-truth generator. SURF-GAN may be used to provide three images, i.e., Iₛ, I_{c}, Iₜ which denote source image 402, canonical image, and target image respectively. Here, parameters 122 (z) are fixed in all images but the view directions of Iₛ and Iₜ are randomly sampled and I_{c} has canonical view direction (i.e., v=[0, 0]). Therefore, they can be exploited as multi-view supervision of the same identity. The generated images may then be embedded to W+ space by a GAN inversion encoder 404 (E), i. e., {w_s, w_c, w_t}={E(I_s), E(I_c), E(I_t)}. FIG. 4 illustrates source image 402 as input to inversion encoder 404. The generated canonical image and target image may separately be converted via inversion encoder 404. In some embodiments, GAN inversion encoder 404 may be a pre-trained pSp encoder as described in Richardson et al., Encoding in style: a stylegan encoder for image-to-image translation, Conference on Computer Vision and Pattern Recognition (CVPR), 2021. GAN inversion encoder 404 in some embodiments predicts the residual and adds it to the mean latent vector.

To handle arbitrary pose without employing off-the-shelf 3D models, framework 400 includes a canonical latent mapper 420 (T), which converts an arbitrary code to a canonical code 422 in the latent space of StyleGAN. The canonical code 422 being a canonical pose (frontal) in image space. Canonical latent mapper 420 T takes wₛ as input and predicts its frontalized version ŵ_{c}=T(wₛ) with the mapping function. In order to train canonical latent mapper 420 T, latent loss may be utilized to minimize the difference between the predicted ŵ_{c} and pseudo ground truth of canonical code w_{c} acquired via GAN inversion encoder 404 based on the generated canonical image. The latent loss may be represented as:

$${ℒ}_{w}^{c} = {‖ {w}_{c} - T ( {w}_{s} ) ‖}_{1} \qquad ( 5 )$$

To guarantee plausible translation result in image space, pixel-level l₂-loss and learned perpetual image patch similarity (LPIPS) loss between two decoded images may be adopted, i.e.,

$${ℒ}_{I}^{c} = {‖ {I}_{c}^{′} - {\hat{I}}_{c} ‖}_{2}^{2} \qquad ( 6 )$$

$${ℒ}_{LPIPS}^{c} = {‖ F ( {I}_{c}^{′} ) - F ( {\hat{I}}_{c} ) ‖}_{2}^{2} \qquad ( 7 )$$

where I_{c}′−Î_{c} represent the decoded images from w_{c} and ŵ_{c} respectively, and F(⋅) denotes the perceptual feature extractor. Hence, the loss for canonical view generation may be formulated by

$${ℒ}^{c} = {λ}_{1} {ℒ}_{w}^{c} + {λ}_{2} {ℒ}_{I}^{c} + {λ}_{3} {ℒ}_{LPIPS}^{c} \qquad ( 8 )$$

where λ₁, λ₂, and λ₃ represent hyperparameters controlling the relative weight of each loss function.

The canonical vector may be converted to a target latent vector 424 according to given a target view 412 vₜ=[α, β] as an additional input. Here, α and β stand for pitch and yaw respectively. The manipulation is conducted in the latent space of StyleGAN by adding a pose vector 414 which is obtained by a linear combination of pitch and yaw vectors (p and y, respectively) with target view 412 vₜ as coefficients, i.e., ŵₜ=ŵ_{c}+Lvₜ^{T}, where L=[p y]. A satisfactory solution for L represents an adequate 3D control over pose. It is observed that the pose-related attribute (e.g., yaw) is not uniquely determined by a single direction. Rather, several orthogonal directions can have different effects on the same attribute. For example, two orthogonal direction A and B both can affect yaw but work differently. Based on this observation, several sub-direction vectors are exploited to compensate marginal portion that is not captured by a single direction vector. The optimal direction that follows real geometry can be obtained by a proper combination of the sub-direction vectors. N learnable basis may be constructed to obtain final pose vectors for pitch and yaw respectively. The matrices P=[d₁^{p}, . . . , d_{N}^{p}] and Y=[d₁^{y}, . . . , d_{N}^{y}] may be optimized accordingly so that when combined with target view 412 and summed with canonical code 422, it produces a target vector 424 that produces an image in the corresponding angle associated with the target view 412. The process to obtain the target vector 424 can be described as,

$${\hat{w}}_{t} = {\hat{w}}_{c} + {\sum }_{i = 1}^{N} ( α \cdot {l}_{i}^{p} {d}_{i}^{p} + β \cdot {l}_{i}^{y} {d}_{i}^{y} ) \qquad ( 9 )$$

where the lᵢ^{p} and lᵢ^{y} represent a learnable scaling factor deciding the importance of basis dᵢ^{p} and dᵢ^{y} respectively. To penalize finding redundant directions, an orthogonal regularization loss may be utilized, i.e.,

$${ℒ}_{reg} = {‖ {P}^{T} P - I ‖}_{1} + {‖ {Y}^{T} Y - I ‖}_{1} \qquad ( 10 )$$

Similar to the canonical view generation, the model is penalized by the difference of the latent codes (wₜ vs. ŵₜ) and that of the corresponding decoded images (Iₜ′ vs. Îₜ). In addition, we also an LPIPS loss may be utilized. Therefore, the objective function of target view generation may be represented as,

$${ℒ}^{t} = {λ}_{4} {ℒ}_{w}^{t} + {λ}_{5} {ℒ}_{I}^{t} + {λ}_{6} {ℒ}_{LPIPS}^{t} + {λ}_{y} {ℒ}_{reg} \qquad ( 11 )$$

where λ₄, λ₅, λ₆, and λ_{y} represent hyperparameters controlling the relative weight of each loss function.

Finally, the full objective to train the modules can be formulated as [symbol] = [symbol] ^{c}+ [symbol] ^{t}. Model 408 may be trained (e.g., parameters may be updated) based on the loss function via backpropagation. For example, parameters of L 410, canonical latent mapper 420, and/or styleGAN generator 426 may be updated. After training, StyleGAN generator 426 (G) becomes a 3D-controllable generator 408 (G_{3D}) with the modules as illustrated in FIG. 4. The image generator 408 may generate a high quality image with intended pose by conditioning view represented as follows,

$${I}_{v} = {G}_{3 D} ( w , {v}_{t} ) = G ( w + T ( w ) + {Lv}_{t}^{T} ) \qquad ( 12 )$$

where Iᵥ represents a generated image 430 with target pose 412 vₜ and styleGAN latent 418 w∈W+ is duplicated version of 512-dimensional style vector in W which is obtained by the mapping network 416 in StyleGAN. Moreover, the method may be extended to synthesize novel view of real images by combining with GAN inversion, i.e.,

$${I}_{v}^{t} = {G}_{3 D} ( E ( {I}^{s} ) , {v}_{t} ) \qquad ( 13 )$$

where I^{s} is an input source image in arbitrary view and Iᵥ^{t} denotes a generated target image 428 with target pose 412 vₜ. Note that this method can handle arbitrary images without exploiting off-the-shelf 3D models such as pose detectors or 3D fitting models. In addition, it synthesizes output at once without an iterative optimization process for overfitting latent code into an input portrait image. Since the trained model 408 may be used for multiple tasks, it may be implemented in a system that allows for flexible use of the model, allowing for user-control (e.g., via a user interface) either explicitly or implicitly, of the functioning of the model. For example, novel-view synthesis of an existing image may be performed when prompted by inputting the source image 402 into inversion encoder 404 and generating novel view image 428. Using the same model 408, image generate with view control may be performed by utilizing mapping network 416 with control parameters 122 and generating the image 430 with the selected view and attributes.

Beyond 3D perception, semantic directions can be discovered in the latent space of StyleGAN that can control facial attributes using SURF-GAN generated images. Such directions can be obtained by vector arithmetic with two latent codes or several interpolated samples generated by SURF-GAN. This approach may provide pose-robust editing directions. The discovery using SURF-GAN is one of multiple approaches and alternative semantic analysis methods may be utilized because the model is flexibly compatible with StyleGAN-based techniques.

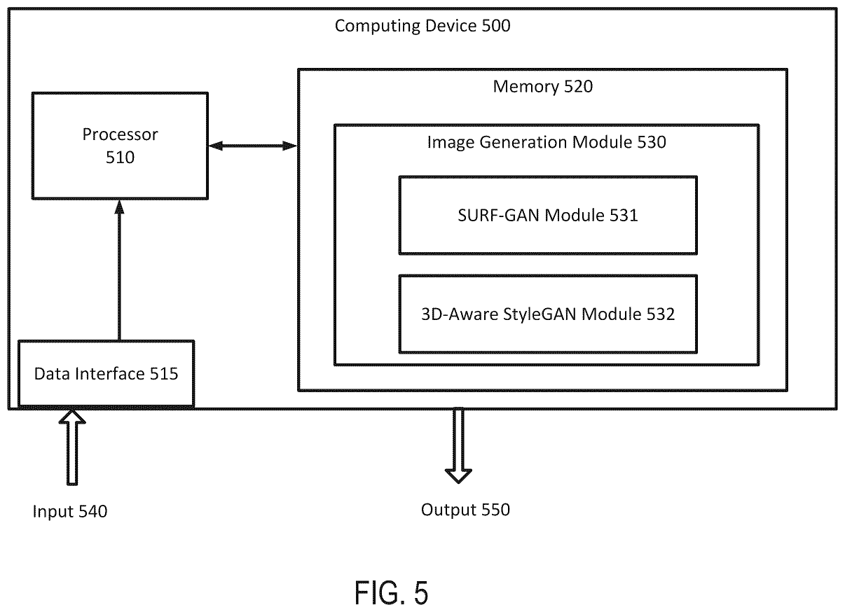

FIG. 5 is a simplified diagram illustrating a computing device 500 implementing the framework described herein, according to some embodiments. As shown in FIG. 5, computing device 500 includes a processor 510 coupled to memory 520. Operation of computing device 500 is controlled by processor 510. And although computing device 500 is shown with only one processor 510, it is understood that processor 510 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 500. Computing device 500 may be implemented as a stand-alone subsystem, as a board added to a computing device, and/or as a virtual machine.

Memory 520 may be used to store software executed by computing device 500 and/or one or more data structures used during operation of computing device 500. Memory 520 may include one or more types of transitory or non-transitory machine-readable media (e.g., computer-readable media). Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 510 and/or memory 520 may be arranged in any suitable physical arrangement. In some embodiments, processor 510 and/or memory 520 may be implemented on a same board, in a same package (e.g., system-in-package), on a same chip (e.g., system-on-chip), and/or the like. In some embodiments, processor 510 and/or memory 520 may include distributed, virtualized, and/or containerized computing resources. Consistent with such embodiments, processor 510 and/or memory 520 may be located in one or more data centers and/or cloud computing facilities.

In some examples, memory 520 may include non-transitory, tangible, machine readable media that includes executable code that when run by one or more processors (e.g., processor 510) may cause the one or more processors to perform the methods described in further detail herein. For example, as shown, memory 520 includes instructions for image generation module 530 that may be used to implement and/or emulate the systems and models, and/or to implement any of the methods described further herein.

Image generation module 530 may include a SURF-GAN module 531 and a 3D-Aware StyleGAN module 532. SURF-GAN module 531 may perform the inference and/or training functions of the SURF-GAN framework described in FIGS. 1-3. 3D-Aware StyleGAN module 532 may perform the inference and/or training functions of the 3D-Aware StyleGAN described in FIG. 4. Modules 531 and 532 may be used together, and functions of each may in some embodiments be formed by the other. For example, SURF-GAN module 531 may generate training images for use by 3D-Aware StyleGAN module 532. Image generation module 530 may receive input 540 such as input images, control parameters, target view directions, etc. and generate an output 550 such as a generated image of a desired style, viewing angle, etc.

The data interface 515 may comprise a communication interface, a user interface (such as a voice input interface, a graphical user interface, and/or the like). For example, the computing device 500 may receive the input 540 from a networked device via a communication interface. Or the computing device 500 may receive the input 540, such as input images, control parameters, etc., from a user via the user interface.

Some examples of computing devices, such as computing device 500 may include non-transitory, tangible, machine readable media that include executable code that when run by one or more processors (e.g., processor 510) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

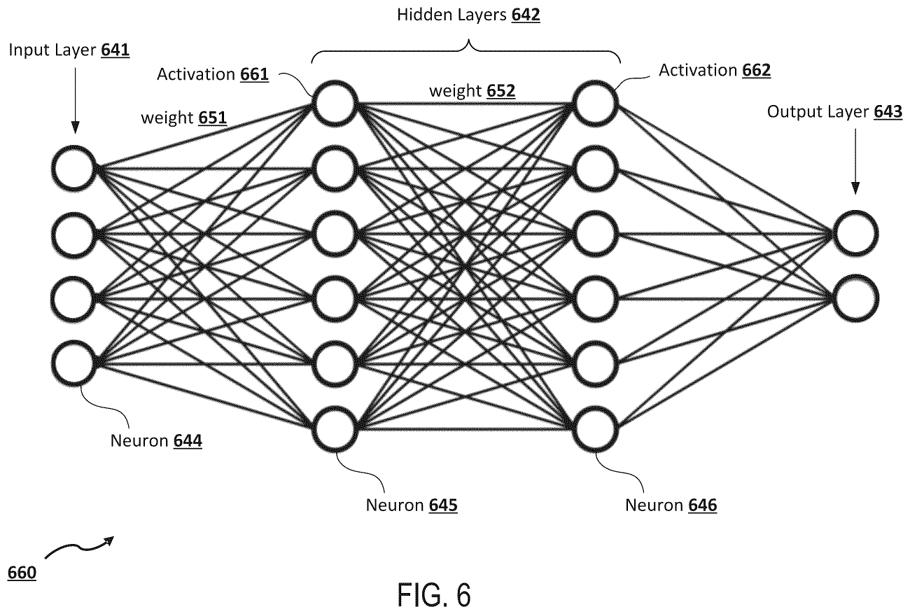

FIG. 6 is a simplified diagram illustrating the neural network structure, according to some embodiments. In some embodiments, the image generation module 530 may be implemented at least partially via an artificial neural network structure shown in FIG. 6. The neural network comprises a computing system that is built on a collection of connected units or nodes, referred to as neurons (e.g., 644, 645, 646). Neurons are often connected by edges, and an adjustable weight (e.g., 651, 652) is often associated with the edge. The neurons are often aggregated into layers such that different layers may perform different transformations on the respective input and output transformed input data onto the next layer.

For example, the neural network architecture may comprise an input layer 641, one or more hidden layers 642 and an output layer 643. Each layer may comprise a plurality of neurons, and neurons between layers are interconnected according to a specific topology of the neural network topology. The input layer 641 receives the input data such as training data, user input data, vectors representing latent features, etc. The number of nodes (neurons) in the input layer 641 may be determined by the dimensionality of the input data (e.g., the length of a vector of the input). Each node in the input layer represents a feature or attribute of the input.

The hidden layers 642 are intermediate layers between the input and output layers of a neural network. It is noted that two hidden layers 642 are shown in FIG. 6 for illustrative purpose only, and any number of hidden layers may be utilized in a neural network structure. Hidden layers 642 may extract and transform the input data through a series of weighted computations and activation functions.

For example, as discussed in FIG. 5, the image generation module 530 receives an input 540 and transforms the input into an output 550. To perform the transformation, a neural network such as the one illustrated in FIG. 6 may be utilized to perform, at least in part, the transformation. Each neuron receives input signals, performs a weighted sum of the inputs according to weights assigned to each connection (e.g., 651, 652), and then applies an activation function (e.g., 661, 662, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 641 is transformed into rather different values indicative data characteristics corresponding to a task that the neural network structure has been designed to perform.

The output layer 643 is the final layer of the neural network structure. It produces the network's output or prediction based on the computations performed in the preceding layers (e.g., 641, 642). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the image generation module 530 may comprise the transformative neural network structure of layers of neurons, and weights and activation functions describing the non-linear transformation at each neuron. Such a neural network structure is often implemented on one or more hardware processors 510, such as a graphics processing unit (GPU).

In one embodiment, the image generation module 530 may be implemented by hardware, software and/or a combination thereof. For example, the image generation module 530 may comprise a specific neural network structure implemented and run on various hardware platforms 660, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 660 used to implement the neural network structure is specifically configured based on factors such as the complexity of the neural network, the scale of the tasks (e.g., training time, input data scale, size of training dataset, etc.), and the desired performance.

In one embodiment, the neural network based image generation module 530 may be trained by iteratively updating the underlying parameters (e.g., weights 651, 652, etc., bias parameters and/or coefficients in the activation functions 661, 662 associated with neurons) of the neural network based on a loss function. For example, during forward propagation, the training data such as source images, target images, canonical images, view angles, control parameters, etc. are fed into the neural network. The data flows through the network's layers 641, 642, with each layer performing computations based on its weights, biases, and activation functions until the output layer 643 produces the network's output 650. In some embodiments, output layer 643 produces an intermediate output on which the network's output 650 is based.

The output generated by the output layer 643 is compared to the expected output (e.g., a “ground-truth” such as the corresponding target image) from the training data, to compute a loss function that measures the discrepancy between the predicted output and the expected output. Given a loss function, the negative gradient of the loss function is computed with respect to each weight of each layer individually. Such negative gradient is computed one layer at a time, iteratively backward from the last layer 643 to the input layer 641 of the neural network. These gradients quantify the sensitivity of the network's output to changes in the parameters. The chain rule of calculus is applied to efficiently calculate these gradients by propagating the gradients backward from the output layer 643 to the input layer 641.

Parameters of the neural network are updated backwardly from the last layer to the input layer (backpropagating) based on the computed negative gradient using an optimization algorithm to minimize the loss. The backpropagation from the last layer 643 to the input layer 641 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as unseen images, view angles, control parameters, etc.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

The neural network illustrated in FIG. 6 is exemplary. For example, different neural network structures may be utilized, and additional neural-network based or non-neural-network based component may be used in conjunction as part of module 530. For example, a text input may first be embedded by an embedding model, a self-attention layer, etc. into a feature vector. The feature vector may be used as the input to input layer 641. Output from output layer 643 may be output directly to a user or may undergo further processing. For example, the output from output layer 643 may be decoded by a neural network based decoder. The neural network illustrated in FIG. 600 and described herein is representative and demonstrates a physical implementation for performing the methods described herein.

Through the training process, the neural network is “updated” into a trained neural network with updated parameters such as weights and biases. The trained neural network may be used in inference to perform the tasks described herein, for example those performed by image generation module 530. The trained neural network thus improves neural network technology in 3D-aware image generation.

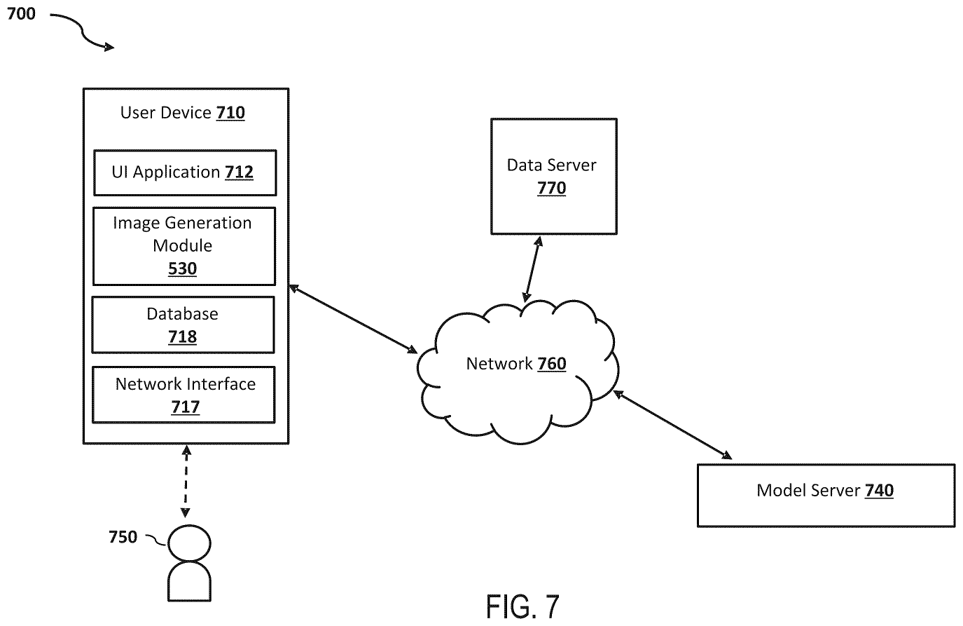

FIG. 7 is a simplified block diagram of a networked system 700 suitable for implementing the framework described herein. In one embodiment, system 700 includes the user device 710 (e.g., computing device 500) which may be operated by user 750, data server 770, model server 740, and other forms of devices, servers, and/or software components that operate to perform various methodologies in accordance with the described embodiments. Exemplary devices and servers may include device, stand-alone, and enterprise-class servers which may be similar to the computing device 500 described in FIG. 5, operating an OS such as a MICROSOFT® OS, a UNIX® OS, a LINUX® OS, a real-time operation system (RTOS), or other suitable device and/or server-based OS. It can be appreciated that the devices and/or servers illustrated in FIG. 7 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities. In some embodiments, user device 710 is used in training neural network based models. In some embodiments, user device 710 is used in performing inference tasks using pre-trained neural network based models (locally or on a model server such as model server 740).

User device 710, data server 770, and model server 740 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 700, and/or accessible over network 760. User device 710, data server 770, and/or model server 740 may be a computing device 500 (or similar) as described herein.

In some embodiments, all or a subset of the actions described herein may be performed solely by user device 710. In some embodiments, all or a subset of the actions described herein may be performed in a distributed fashion by various network devices, for example as described herein.

User device 710 may be implemented as a communication device that may utilize appropriate hardware and software configured for wired and/or wireless communication with data server 770 and/or the model server 740. For example, in one embodiment, user device 710 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 710 of FIG. 7 contains a user interface (UI) application 712, and image generation module 530, which may correspond to executable processes, procedures, and/or applications with associated hardware. For example, the user device 710 may allow a user to generate images or modify the view of an image as described herein. In other embodiments, user device 710 may include additional or different modules having specialized hardware and/or software as required.

In various embodiments, user device 710 includes other applications as may be desired in particular embodiments to provide features to user device 710. For example, other applications may include security applications for implementing client-side security features, programmatic client applications for interfacing with appropriate application programming interfaces (APIs) over network 760, or other types of applications. Other applications may also include communication applications, such as email, texting, voice, social networking, and IM applications that allow a user to send and receive emails, calls, texts, and other notifications through network 760.

Network 760 may be a network which is internal to an organization, such that information may be contained within secure boundaries. In some embodiments, network 760 may be a wide area network such as the internet. In some embodiments, network 760 may be comprised of direct physical connections between the devices. In some embodiments, network 760 may represent communication between different portions of a single device (e.g., a communication bus on a motherboard of a computation device).

Network 760 may be implemented as a single network or a combination of multiple networks. For example, in various embodiments, network 760 may include the Internet or one or more intranets, landline networks, wireless networks, and/or other appropriate types of networks. Thus, network 760 may correspond to small scale communication networks, such as a private or local area network, or a larger scale network, such as a wide area network or the Internet, accessible by the various components of system 700.

User device 710 may further include database 718 stored in a transitory and/or non-transitory memory of user device 710, which may store various applications and data (e.g., model parameters) and be utilized during execution of various modules of user device 710. Database 718 may store images, parameters, etc. In some embodiments, database 718 may be local to user device 710. However, in other embodiments, database 718 may be external to user device 710 and accessible by user device 710, including cloud storage systems and/or databases that are accessible over network 760 (e.g., on data server 770).

User device 710 may include at least one network interface component 717 adapted to communicate with data server 770 and/or model server 740. In various embodiments, network interface component 717 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data Server 770 may perform some of the functions described herein. For example, data server 770 may store a training dataset including source images, target images, canonical images, control parameters, view directions, etc. Data server 770 may provide data to user device 710 and/or model server 740. For example, training data may be stored on data server 770 and that training data may be retrieved by model server 740 while training a model stored on model server 740.

Model server 740 may be a server that hosts models described herein. Model server 740 may provide an interface via network 760 such that user device 710 may perform functions relating to the models as described herein (e.g., image generation, novel view synthesis, and/or view controlled image generation). Model server 740 may communicate outputs of the models to user device 710 via network 760. User device 710 may display model outputs, or information based on model outputs, via a user interface to user 750.

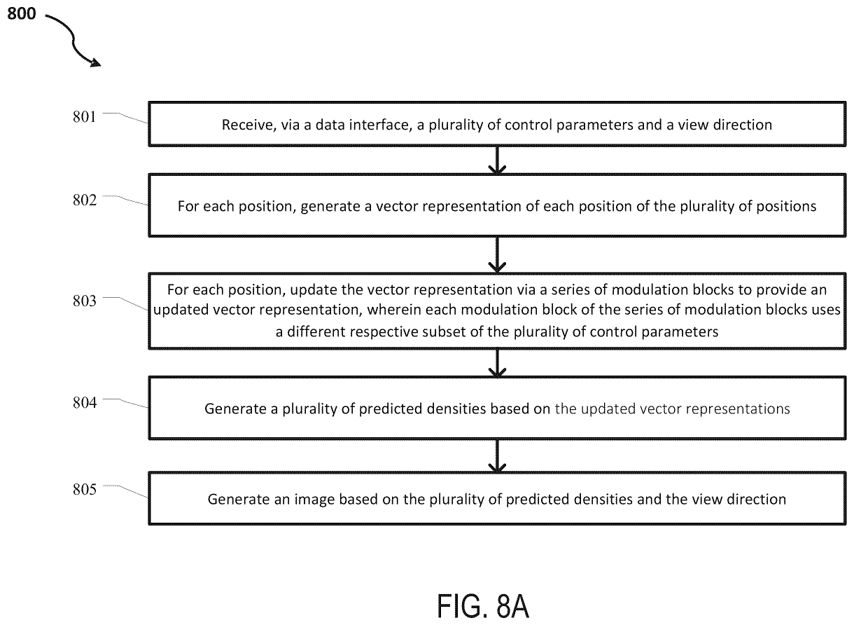

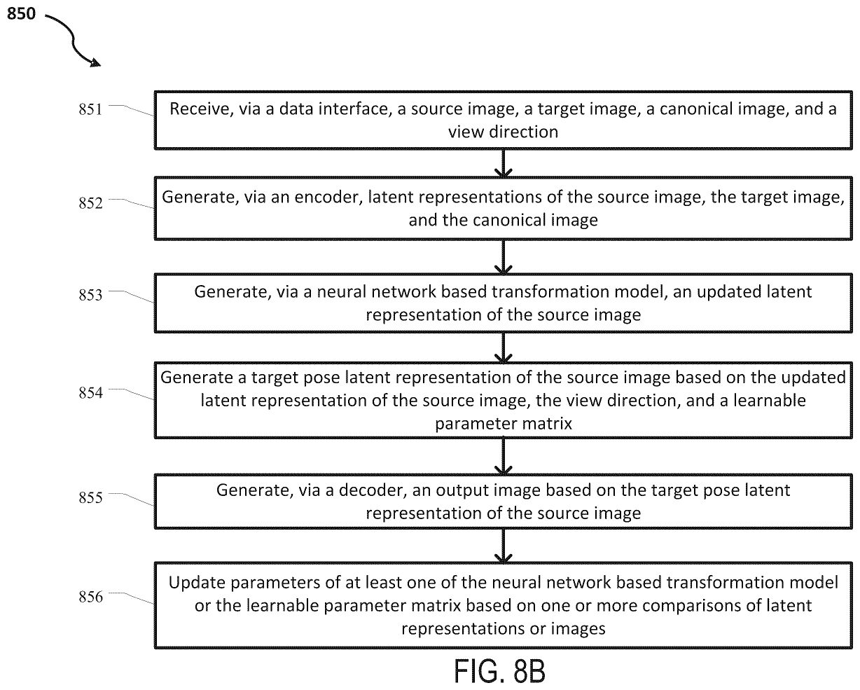

FIG. 8A is an example logic flow diagram, according to some embodiments described herein. One or more of the processes of method 800 may be implemented, at least in part, in the form of executable code stored on non-transitory, tangible, machine-readable media that when run by one or more processors may cause the one or more processors to perform one or more of the processes (e.g., computing device 500). In some embodiments, method 800 corresponds to the operation of the image generation module 530 that performs image generation.

As illustrated, the method 800 includes a number of enumerated steps, but aspects of the method 800 may include additional steps before, after, and in between the enumerated steps. In some aspects, one or more of the enumerated steps may be omitted or performed in a different order.

At step 801, a system (e.g., computing device 500, user device 710, model server 740, device 900, or device 915) receives, via a data interface (e.g., data interface 515, network interface 717, or an interface to a sensor such as a camera) a plurality of control parameters (e.g., control parameters 122) and a view direction (e.g., view direction 116).

At step 802, the system generates for each position a vector representation (e.g., via linear layer 106) of each position of the plurality of positions. For example, position 102 may be updated for each inference so that each defined position has a density and/or color computed. In some embodiments, noise may be added to the vector representation of the position.

At step 803, the system updates for each position the vector representation via a series of modulation blocks (e.g., SURF blocks 108) to provide an updated vector representation, wherein each modulation block of the series of modulation blocks uses a different respective subset of the plurality of control parameters (e.g., as indicated by the i indices of the control parameters in FIG. 1). In some embodiments, updating the vector representation includes generating, by each modulation block of the series of modulation blocks, a plurality of frequency values (e.g., frequencies 206) and a plurality of offset values (e.g., phase shifts 208) based on an affine transformation (e.g., affine transformation 220) of the respective subset of the plurality of control parameters. In some embodiments, updating the vector representation further includes updating the vector representation based on the plurality of frequency values and the plurality of offset values. In some embodiments, updating the vector representation further includes adding (e.g., via addition 216), by each modulation block of the series of modulation blocks, an input vector representation (e.g., input 202) as input to each respective modulation block to an output vector representation (e.g., the output of sin function 214) as modulated by each respective modulation block.

At step 804, the system generates a plurality of predicted densities (e.g., density 114) based on the updated vector representations. In some embodiments, the generating the plurality of predicted densities includes generating each density of the plurality of predicted densities via a neural network based transformation (e.g., linear layer 112) based on the updated vector representation. In some embodiments, the system further generates a plurality of predicted colors based on the plurality of positions and the plurality of control parameters. In some embodiments, the generating the plurality of predicted colors includes updating the updated vector representation via a modulation block (e.g., SURF block 108d) not in the series of modulation blocks to provide a second updated vector representation. Generating the plurality of predicted colors may further include generating each color of the plurality of predicted colors via a neural network based transformation (e.g., linear layer 118) based on the second updated vector representation. In some embodiments, generating the plurality of predicted colors via the neural network based transformation is further based on the view direction.

At step 805, the system generates an image based on the plurality of predicted densities and the view direction. For example, the points are sampled from rays of camera, and then an image is rendered into 2D grid with a volume rendering technique based on the associated densities and/or colors predicted for each location. In some embodiments, the generating the image is further based on the plurality of predicted colors.

FIG. 8B is an example logic flow diagram, according to some embodiments described herein. One or more of the processes of method 850 may be implemented, at least in part, in the form of executable code stored on non-transitory, tangible, machine-readable media that when run by one or more processors may cause the one or more processors to perform one or more of the processes (e.g., computing device 500). In some embodiments, method 850 corresponds to the operation of the image generation module 530 that performs novel view synthesis.

As illustrated, the method 850 includes a number of enumerated steps, but aspects of the method 850 may include additional steps before, after, and in between the enumerated steps. In some aspects, one or more of the enumerated steps may be omitted or performed in a different order.

At step 851, a system (e.g., computing device 500, user device 710, model server 740, device 900, or device 915) receives, via a data interface (e.g., data interface 515, network interface 717, or an interface to a sensor such as a camera) a source image, a target image, a canonical image, and a view direction (e.g., target view 412). In some embodiments, the view direction is represented as a pitch value and a yaw value. In some embodiments, the source image, target image, and/or canonical image are generated by framework 100 as described herein. For example, the same control parameters may be used for each image, but with different view directions.

At step 852, the system generates, via an encoder (e.g., Inversion Encoder 404), latent representations of the source image (e.g., inverted latent 406), the target image, and the canonical image.

At step 853, the system generates, via a neural network based transformation model (e.g., canonical latent mapper 420), an updated latent representation of the source image (e.g., canonical code 422). The updated latent representation may be a latent representation of the source image updated to represent a (0,0) view direction (e.g., face-on). In some embodiments, the neural network based transformation model is a fully-connected multi-layer perceptron.

At step 854, the system generates a target pose latent representation of the source image (e.g., target code 424) based on the updated latent representation of the source image, the view direction, and a learnable parameter matrix (e.g., parameters 410). In some embodiments, generating the target pose latent representation of the input image includes summing the updated latent representation with a product of the view direction and the learnable parameter matrix.

At step 855, the system generates, via a decoder (e.g., generator 426), an output image based on the target pose latent representation of the source image. In some embodiments, if the desired pose of the output image is the canonical view, the output image may be generated by the decoder based on the updated latent representation of the source image, without needing to perform step 854.

At step 856, the system updates parameters of at least one of the neural network based transformation model or the learnable parameter matrix based on one or more comparisons of latent representations or images. For example, one or more loss functions may be utilized as described herein in FIGS. 1-4. In some embodiments, a first loss function is based on a comparison of the target image and the output image. In some embodiments, a second loss function is based on a comparison of the target pose latent representation of the source image and the latent representation of the target image. In some embodiments, a third loss function is based on a comparison of the updated latent representation of the source image and the latent representation of the canonical image. In some embodiments, a canonical (face-on) image may be generated via the decoder based on the updated vector representation. A fourth loss may be based on a comparison of the generated canonical image and the canonical image. The various losses may be used in any combination, and/or there may be additional loss functions as described herein.

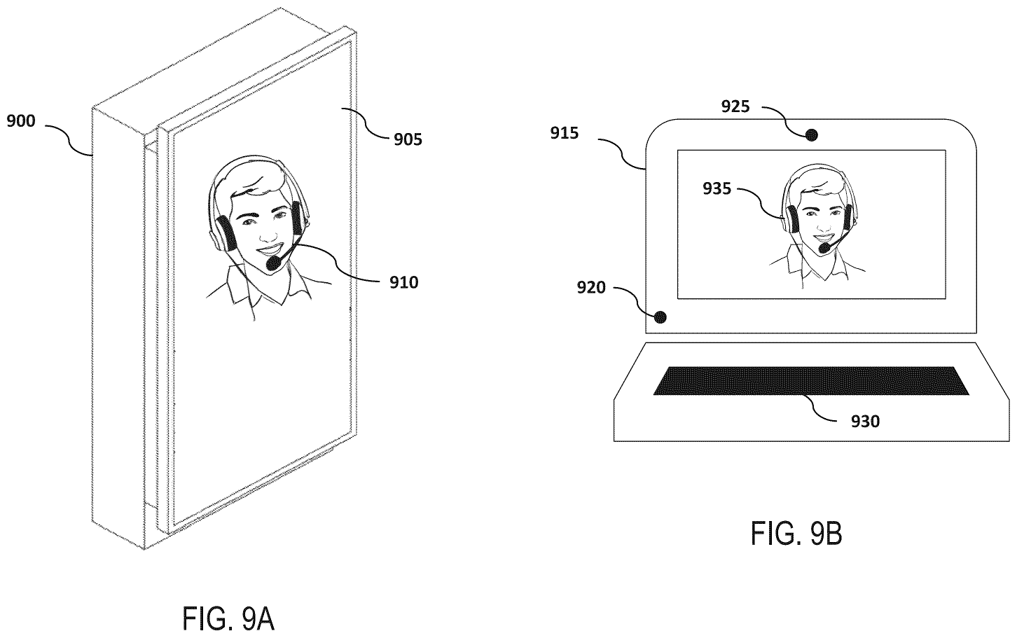

FIG. 9A is an exemplary device 900 with a digital avatar interface, according to some embodiments. Device 900 may be, for example, a kiosk that is available for use at a store, a library, a transit station, etc. Device 900 may display a digital avatar 910 on display 905. In some embodiments, a user may interact with the digital avatar 910 as they would a person, using voice and non-verbal gestures. Digital avatar 910 may interact with a user via digitally synthesized gestures, digitally synthesized voice, etc. In some embodiments, the view position of digital avatar 910 may be modified using embodiments described herein. For example, a canonical view of digital avatar 910 may be generated first, then using framework 400, novel views may be generated of digital avatar 910.

Device 900 may include one or more microphones, and one or more image-capture devices (not shown) for user interaction. Device 900 may be connected to a network (e.g., network 760). Digital Avatar 910 may be controlled via local software and/or through software that is at a central server accessed via a network. For example, an AI model may be used to control the behavior of digital avatar 910, and that AI model may be run remotely. In some embodiments, device 900 may be configured to perform functions described herein (e.g., via digital avatar 910). For example, device 900 may perform one or more of the functions as described with reference to computing device 500 or user device 710. For example, 3-D aware image generation, novel view synthesis, etc. using the frameworks described herein.

FIG. 9B is an exemplary device 915 with a digital avatar interface, according to some embodiments. Device 915 may be, for example, a personal laptop computer or other computing device. Device 915 may have an application that displays a digital avatar 935 with functionality similar to device 900. For example, device 915 may include a microphone 920 and image capturing device 925, which may be used to interact with digital avatar 935. In addition, device 915 may have other input devices such as a keyboard 930 for entering text.

Digital avatar 935 may interact with a user via digitally synthesized gestures, digitally synthesized voice, etc. In some embodiments, the view position of digital avatar 935 may be modified using embodiments described herein. For example, a canonical view of digital avatar 935 may be generated first, then using framework 400, novel views may be generated of digital avatar 935. In some embodiments, device 915 may be configured to perform functions described herein (e.g., via digital avatar 935). For example, device 915 may perform one or more of the functions as described with reference to computing device 500 or user device 710. For example, 3-D aware image generation, novel view synthesis, etc. using the frameworks described herein.

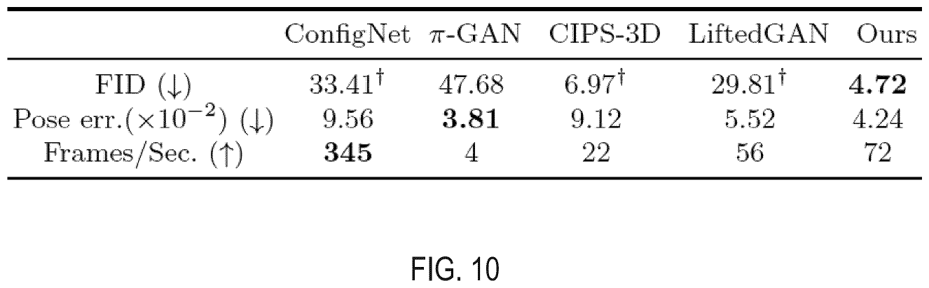

FIGS. 10-13 provide charts illustrating exemplary performance of different embodiments described herein. Baseline models utilized in the experiments include ConfigNet as described in Kowalski et al., Config: Controllable neural face image generation, European Conference on Computer Vision, 2020; π-GAN as described in Chan et al., pi-gan: Periodic implicit generative adversarial networks for 3d-aware image synthesis, Conference on Computer Vision and Pattern Recognition, 2021; CIPS-3D as described in Zhou et al., Cips-3d: A 3d-aware generator of gans based on conditionally-independent pixel synthesis, arXiv: 2110.09788, 2021; and Lifted GAN as described in Shi et al., Lifting 2D StyleGAN for 3D-Aware Face Generation, arXiv: 2011.13126, 2020. Datasets utilized include CelebA as described in Liu et al., Deep learning face attributed in the wild, Conference on Computer Vision and Pattern Recognition, 2015; FFHQ as described in Karras et al., A style-based generator architecture for generative adversarial networks, Conference on Computer Vision and Pattern Recognition, 2019; and R&R as described in Zhou et al., Rotate-and-render: Unsupervised photorealistic face rotation from single-view images, Conference on Computer Vision and Pattern Recognition, 2020.

Experiments showed that SURF-GAN can synthesize a view-conditioned image, i.e., yaw and pitch can be controlled explicitly with input view direction. In contrast to other 3D NeRF-GANS, SURF-GAN can discover semantic attributes in different layers in an unsupervised manner. Additionally, the discovered attributes can be manipulated by the corresponding control parameters. Different layers of SURF-GAN capture diverse attributes such as gender, hair color, illumination, etc. Further, the early layers capture high-level semantics (e.g., overall shape or gender) and the rear layers focus fine details or texture (e.g., illumination or hue). This property is similar to that seen in 2D GANs even though SURF-GAN consists of multi-layer perceptrons (MLPs) without convolutional layers.

FIG. 10 illustrates a quantitative comparison of the 3D controllable StyleGAN (labeled “ours”) with other 3D controllable generative models. Evaluations was performed on FID, pose accuracy, and frames per second. Compared to 3D-aware models, our method achieves a competitive score on pose accuracy and delivers superior results in efficiency, visual quality, and Multiview consistency. Although 2D-based ConfigNet shows overwhelming efficiency, it struggles with multi-view consistency and photorealism.

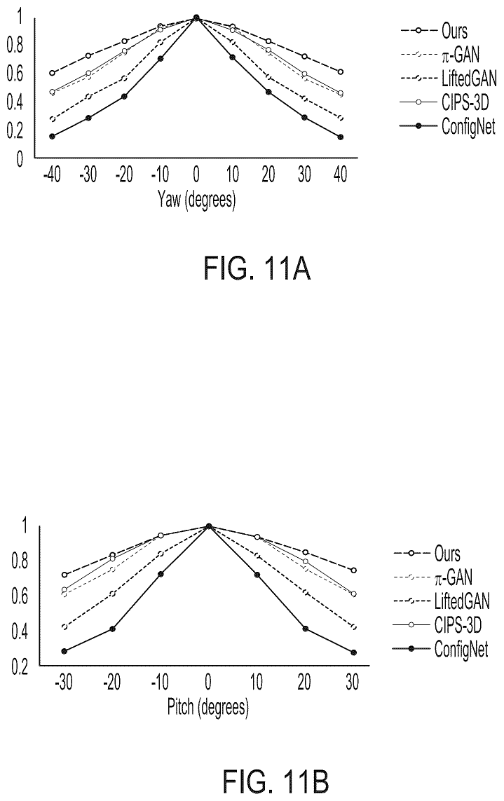

FIGS. 11A-11B illustrate quantitative comparisons of 3D controllable StyleGAN (labeled “ours”) with other 3D controllable generative models on identity preservation under different angles using the averaged cosine similarity metric as described in Deng et al., Arcface: Additive angular margin loss for deep face recognition, Conference on Computer Vision and Pattern Recognition, 2019. As illustrated, 3D controllable StyleGAN as described herein outperforms the other baseline models for both yaw and pitch rotations.

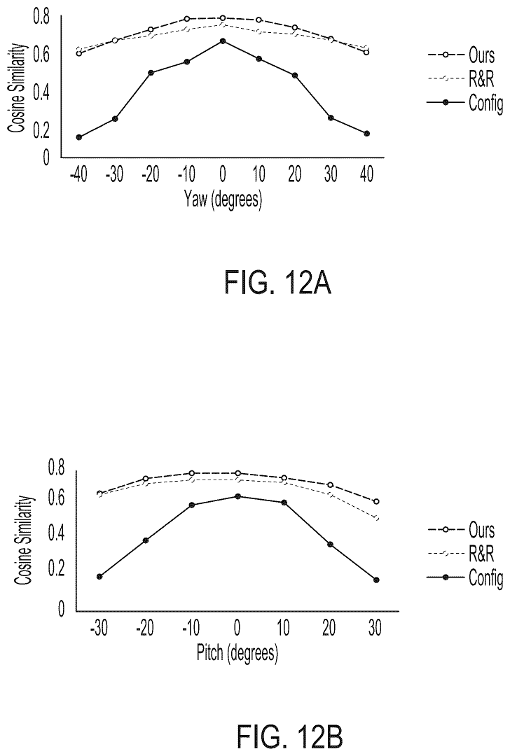

FIGS. 12A-12B illustrate quantitative comparisons of novel view synthesis utilizing a method described here (labeled “ours”) compared to R&R and ConfigNET methods. Identity similarity was computed between input and synthesized images using Arcface.

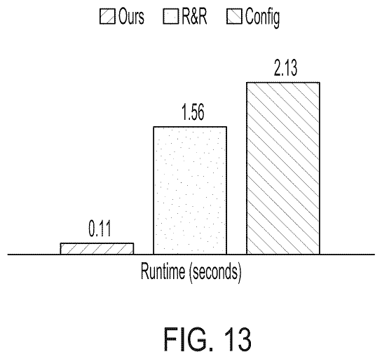

FIG. 13 illustrates a comparison of runtimes in seconds for novel view synthesis utilizing a method described here (labeled “ours”) compared to R&R and ConfiNET methods. As illustrated, the runtime required by the method described herein is significantly lower than the baseline models.

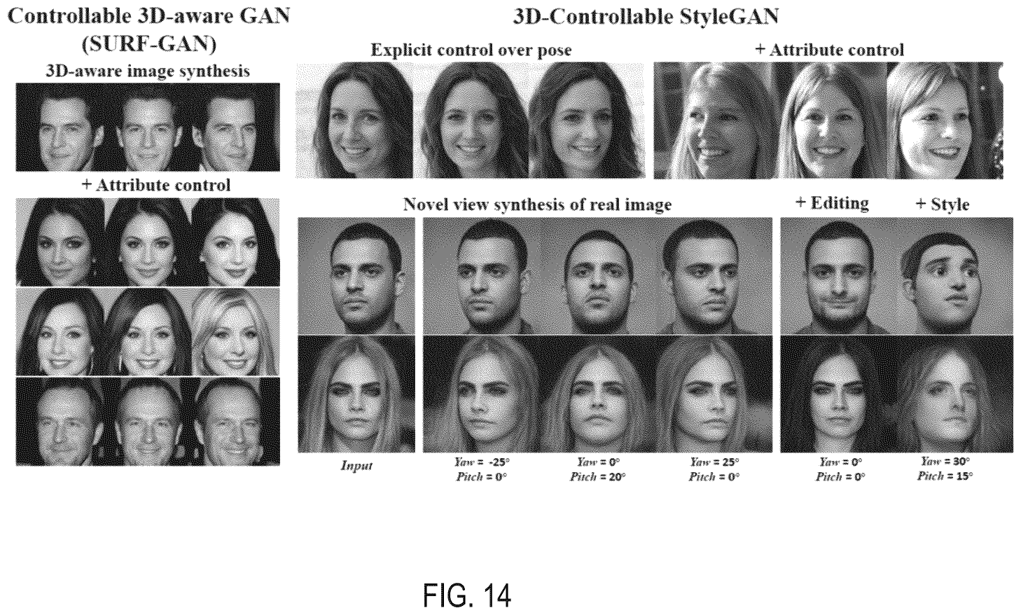

FIG. 14 illustrates exemplary generated images, according to some embodiments. The illustrated images on the left represent images generated by a SURF-GAN model as described in FIGS. 1-3 and elsewhere herein, showing capability of attribute-controllable generation as well as 3D-aware synthesis. The images on the right represent images generated by a 3D-controllable StyleGAN as described in FIG. 4 and elsewhere herein, showing the capability in explicit control over pose, attribute control, novel view synthesis of real images including with editing and style control.

The devices described above may be implemented by one or more hardware components, software components, and/or a combination of the hardware components and the software components. For example, the device and the components described in the exemplary embodiments may be implemented, for example, using one or more general purpose computers or special purpose computers such as a processor, a controller, an arithmetic logic unit (ALU), a digital signal processor, a microcomputer, a field programmable gate array (FPGA), a programmable logic unit (PLU), a microprocessor, or any other device which executes or responds instructions. The processing device may perform an operating system (OS) and one or more software applications which are performed on the operating system. Further, the processing device may access, store, manipulate, process, and generate data in response to the execution of the software. For ease of understanding, it may be described that a single processing device is used, but those skilled in the art may understand that the processing device includes a plurality of processing elements and/or a plurality of types of the processing element. For example, the processing device may include a plurality of processors or include one processor and one controller. Further, another processing configuration such as a parallel processor may be implemented.

The software may include a computer program, a code, an instruction, or a combination of one or more of them, which configure the processing device to be operated as desired or independently or collectively command the processing device. The software and/or data may be interpreted by a processing device or embodied in any tangible machines, components, physical devices, computer storage media, or devices to provide an instruction or data to the processing device. The software may be distributed on a computer system connected through a network to be stored or executed in a distributed manner The software and data may be stored in one or more computer readable recording media.

The method according to the exemplary embodiment may be implemented as a program instruction which may be executed by various computers to be recorded in a computer readable medium. At this time, the medium may continuously store a computer executable program or temporarily store it to execute or download the program. Further, the medium may be various recording means or storage means to which a single or a plurality of hardware is coupled and the medium is not limited to a medium which is directly connected to any computer system, but may be distributed on the network. Examples of the medium may include magnetic media such as hard disk, floppy disks and magnetic tapes, optical media such as CD-ROMs and DVDs, magneto-optical media such as optical disks, and ROMs, RAMS, and flash memories to be specifically configured to store program instructions. Further, an example of another medium may include a recording medium or a storage medium which is managed by an app store which distributes application, a site and servers which supply or distribute various software, or the like.

Although the exemplary embodiments have been described above by a limited embodiment and the drawings, various modifications and changes can be made from the above description by those skilled in the art. For example, even when the above-described techniques are performed by different order from the described method and/or components such as systems, structures, devices, or circuits described above are coupled or combined in a different manner from the described method or replaced or substituted with other components or equivalents, the appropriate results can be achieved. It will be understood that many additional changes in the details, materials, steps and arrangement of parts, which have been herein described and illustrated to explain the nature of the subject matter, may be made by those skilled in the art within the principle and scope of the invention as expressed in the appended claims.

What is claimed is:

1. A method of image generation, the method comprising:
receiving, via a data interface, a plurality of control parameters and a view direction;
generating a plurality of predicted densities based on a plurality of positions and the plurality of control parameters; and
generating an image based on the plurality of predicted densities and the view direction.

2. The method of claim 1, wherein the generating the plurality of predicted densities includes:
generating a vector representation of each position of the plurality of positions; and
updating the vector representation via a series of modulation blocks to provide an updated vector representation, wherein each modulation block of the series of modulation blocks uses a different respective subset of the plurality of control parameters.

3. The method of claim 2, wherein the updating the vector representation includes:
generating, by each modulation block of the series of modulation blocks, a plurality of frequency values and a plurality of offset values based on an affine transformation of the respective subset of the plurality of control parameters; and
updating the vector representation based on the plurality of frequency values and the plurality of offset values.

4. The method of claim 3, wherein the updating the vector representation further includes:
adding, by each modulation block of the series of modulation blocks, an input vector representation as input to each respective modulation block to an output vector representation as modulated by each respective modulation block.

5. The method of claim 3, wherein the generated image is a first image, further comprising:
generating a second image based on the plurality of predicted densities and a canonical view direction;
generating, via an encoder, a latent representation of the first image;
generating, via the encoder, a latent representation of the second image;
generating, via a neural network based transformation model, an updated latent representation of the first image; and
updating parameters of the neural network based transformation model based on a comparison of the updated latent representation of the first image and the latent representation of the second image.

6. The method of claim 5, further comprising:
generating, via a decoder, a third image based on the updated latent representation of the first image;
generating, via the decoder, a fourth image based on the latent representation of the second image; and
updating parameters of the neural network based transformation model based on a comparison of the third image and the fourth image.

7. The method of claim 5, wherein the view direction is a first view direction, further comprising:
receiving, via the data interface, a second view direction;
generating a third image based on the plurality of predicted densities and the second view direction;
generating a target pose latent representation of the first image based on the updated latent representation of the first image, the second view direction, and a learnable parameter matrix;
generating, via a decoder, a fourth image based on the target pose latent representation of the first image; and
updating parameters of the learnable parameter matrix based on a comparison of the third image and the fourth image.

8. The method of claim 7, further comprising:
generating, via an encoder, a latent representation of the third image; and
updating parameters of the learnable parameter matrix based on a comparison of the target pose latent representation of the first image and the latent representation of the third image.

9. The method of claim 2, wherein the generating the plurality of predicted densities includes generating each density of the plurality of predicted densities via a neural network based transformation based on the updated vector representation.

10. The method of claim 2, further comprising:
generating a plurality of predicted colors based on a plurality of positions and the plurality of control parameters,
wherein the generating the image is further based on the plurality of predicted colors.

11. The method of claim 10, wherein the generating the plurality of predicted colors includes:
updating the updated vector representation via a modulation block not in the series of modulation blocks to provide a second updated vector representation; and
generating each color of the plurality of predicted colors via a neural network based transformation based on the second updated vector representation.

12. The method of claim 11, wherein the generating each color of the plurality of predicted colors via the neural network based transformation is further based on the view direction.

13. A method of image generation, the method comprising:
receiving, via a data interface, an input image and a view direction;
generating, via an encoder, a latent representation of the input image;
generating, via a neural network based transformation model, an updated latent representation of the input image;
generating a target pose latent representation of the input image based on the updated latent representation of the input image, the view direction, and a learnable parameter matrix; and
generating, via a decoder, an output image based on the target pose latent representation of the input image.

14. The method of claim 13, further comprising:
receiving, via the data interface a target image; and
updating parameters of at least one of the neural network based transformation model or the learnable parameter matrix based on a comparison of the target image and the output image.

15. The method of claim 13, further comprising:
receiving, via the data interface a target image;
generating, via the encoder, a latent representation of the target image; and
updating parameters of at least one of the neural network based transformation model or the learnable parameter matrix based on a comparison of the target pose latent representation of the input image and the latent representation of the target image.

16. The method of claim 13, wherein generating the target pose latent representation of the input image includes summing the updated latent representation with a product of the view direction and the learnable parameter matrix.

17. A method of image generation, the method comprising:
receiving, via a data interface, a plurality of control parameters and a view direction;
generating, via a mapping network, a latent representation of an image based on the plurality of control parameters;
generating, via a neural network based transformation model, an updated latent representation based on the latent representation of the image;
generating a target pose latent representation based on the latent representation, the view direction, and a learnable parameter matrix; and
generating, via a decoder, an output image based on the target pose latent representation.

18. The method of claim 17, wherein the view direction is represented as a pitch value and a yaw value.

19. The method of claim 17, wherein the neural network based transformation model is a fully-connected multi-layer perceptron.

20. The method of claim 17, wherein generating the target pose latent representation includes summing the updated latent representation with a product of the view direction and the learnable parameter matrix.
